(19) United States
(12) Patent Application Publication
(10) Pub. No.: US 2011/0171593 A1
(43) Pub. Date: Jul. 14, 2011

(54) DYNAMICALLY ADJUSTABLE DENTAL IMPRESSION DEVICES AND METHODS FOR USING THE SAME

(76) Inventor: Donald H. Ross, Atlanta, GA (US)

(21) Appl. No.: 12/686,295

(22) Filed: Jan. 12, 2010

(51) Int. Cl. A61C 9/00

(52) U.S. Cl. 433/41; 433/214

(57) ABSTRACT

The present invention describes systems and methods to provide dynamically adjustable dental impression devices. In an exemplary embodiment, the present invention provides a dynamically adjustable dental impression device including a facial portion having at least a first wall and a lingual portion having at least a first wall. The facial portion is movably connected to the lingual portion to form an internal cavity enabled to receive a quantity of impression material. Furthermore, the size of the internal cavity can be reduced during the formation of an impression of a dental structure. In some embodiments, the facial portion can be contracted with the lingual portion during the formation on the impression of the dental structure, resulting in the reduction in the size of the internal cavity. Additionally, in some embodiments, the reduction in the size of the internal cavity during the formation on the impression of the dental structure can increase the hydrostatic pressure within the quantity of impression material. Furthermore, the dynamically adjustable dental impression device can simultaneously apply forces substantially nonparallel and substantially parallel to the long axis of the tooth in the dental structure.

### FIELD OF THE INVENTION

The present invention relates generally to systems and methods for providing dental impressions and, more particularly, to systems and methods for providing dynamically adjustable dental impression devices.

### BACKGROUND OF THE INVENTION

In dental therapeutics, the ability to create an accurate model of various dental structures, such as portions of a patient's teeth, tooth formations, implant parts, the contour of the gum, and adjacent portions of the jaw, is often critical to a successful procedure. An impression is often used to create an imprint or negative likeness of the teeth and/or implant related parts and adjacent portions of the jaw preparatory to dental repair, orthodontics and restoration or replacement of missing dental structures. Impressions are typically made by placing a soft, semi-fluid material within the confines of an open trough or channel of a unitary straight or arcuate tray, which is then positioned within the mouth of a patient, and allowing the material to set or cure. Depending upon the material used, the set impression may have varying degrees of elastic characteristics. The impression cast can be used to establish inter-proximal contacts, buccal and lingual contours and occlusion with the opposing teeth and other dental relationships. From the negative or female impression of the teeth and on implant related parts and surrounding structures, a positive reproduction or male cast may be created for the purpose of fabricating inlays, crowns, bridge retainers, dentures, restorations or other similar dental prosthetics.

A damaged tooth is prepared for receiving artificial crowns or other dental restorations by removal of portions of the tooth. The junctions where the uncut lower (apical) portion of the tooth meets the cut upper (occlusal) portion of the tooth are commonly referred to as the “margins” of the tooth. An artificial crown can be fabricated based on an impression of the tooth including the margin area of the tooth and gingival surrounding the margins. Thus, the impression of the margins of the tooth must be sufficiently detailed to allow for proper fabrication of an artificial crown. For example, in dental therapeutics an impression is often made of a tooth after it is prepared for an indirect restoration such as a crown or onlay. With conventional systems, a flowable impression material is often syringed around the teeth to aid the impression provided by the impression material in the tray. The tray with the impression material is then placed into the mouth over the teeth being impressed until the material is set.

When a dental operator makes an impression in the mouth of a dental subject, of dental structures such as teeth, gums or implant parts, a conventional dental impression tray is typically used to contain and position most of the impression material that will be placed onto the oral structures to make a dental impression (mold). Conventional impression material may be polyvinyl or polyether or hydrocolloid or some other product with similar properties and typically the impression material sets to a rubbery consistency. The impression of a tooth before it is prepared for an indirect restoration such as a crown can be the mold for a temporary restoration. The impression of a tooth after it is prepared for a final restoration is used as a mold to make a model of the tooth from which the restoration is made.

There are many types of conventional trays for putting impression materials in place and holding them there while they set. The conventional trays are typically metal or plastic or material of similar strengths and stiffness. Additionally, conventional impression tray systems typically provide the dentist with three or more size choices in attempt to accommodate small to large size mouths. The walls of conventional impression trays are typically parallels to each other or diverge from each other as they extend away from the horizontal portion of the tray. These conventional stock size impression trays cannot be individually adapted to the teeth, so they typically require a relatively large amount of impression material and may not be as accurate as customized trays. Conventional systems can enable the creation of customized impression trays from impressions made with stock size impression trays or they can be created with thermoplastic material heated and adapted to the oral area of interest. Although these systems allow for customized impression trays, the extra steps required to create the custom tray are relatively expensive and time consuming.

Another type of conventional tray is the bite tray, which has a thin film or webbing that holds upper and lower impression materials at the same time. A conventional bite tray creates an upper and lower impression and a bite relation all at the same time when the patient bites into the tray. These bite tray impressions can result in distorted and inaccurate impressions if the lab does not pour the impression correctly (which is more difficult than with standard tray), the patient does not bite correctly or the oral tissues impinge on the tray. Conventional impression techniques often involve the use of a thinner, flowable impression material that is syringed around the area of importance and/or into the already set first stage impression material. This syringing technique is more time consuming and can lead to distortion by way of rebound if syringed into an already set preliminary impression when the tray is removed from the mouth.

Some conventional impression trays can be adjusted, whereby the tray is altered in length, anterior to posterior, or in outside dimension from right side buccal to left side buccal. These adjustments, however, are passive adjustments that are done before the impression material is mixed and before the impression is formed. Typically, the walls of the conventional adjustable impression trays are held in final position by screws or lugs that must be tightened into place before the formation of the impression.

Conventional impression trays often result in a void between the material and the dental structures being impressed. These imperfections are often caused by air bubbles, contamination from tissue fluid, including blood, or by pulls on the thinner syringed material usually placed around the tooth or other dental structures of interest before the tray and its impression material is placed. These pulls can occur as the material in the conventional tray moves vertically past the area of interest, such as a margin of a tooth being prepared for a crown. This is more likely to happen when the material is setting before final positioning of the tray, creating more drag.

Therefore, it would be advantageous to provide an apparatus and method for efficiently and effectively providing dental impressions.

Additionally, it would be advantageous to provide an apparatus and method to provide an adjustable dental impression device that can be dynamically adjusted during the formation of an impression.

Additionally, it would be advantageous to provide an improved system and method for forming an impression that allows the dental operator to control the timing and vector of the forces applied to the impression material during the formation of the impression.

### BRIEF SUMMARY OF THE INVENTION

The present invention describes systems and methods to provide dynamically adjustable dental impression devices. In an exemplary embodiment, the present invention provides a dynamically adjustable dental impression device including a facial portion having at least a first wall and a lingual portion having at least a first wall. The facial portion is movably connected to the lingual portion to form an internal cavity enabled to receive a quantity of impression material. Furthermore, the size of the internal cavity can be reduced during the formation of an impression of a dental structure.

In some embodiments, the facial portion can be contracted with the lingual portion during the formation on the impression of the dental structure, resulting in the reduction in the size of the internal cavity. Additionally, in some embodiments, the reduction in the size of the internal cavity during the formation on the impression of the dental structure can increase the hydrostatic pressure within the quantity of impression material. Furthermore, the dynamically adjustable dental impression device can simultaneously apply forces substantially nonparallel and substantially parallel to the long axis of the tooth in the dental structure.

In addition to adjustable dental impression devices, the present invention provides methods for forming a dental impression. An exemplary embodiment of the method for forming a dental impression involves providing a dynamically adjustable dental impression device comprising a facial portion having at least a first wall and a lingual portion having at least a first wall. The facial portion is moveably connected to the lingual portion to form an internal cavity enabled to receive a quantity of impression material. The method for forming a dental impression further involves inserting the quantity of impression material into the internal cavity. Additionally, the method involves forming an impression by pressing a portion of the quantity of impression material in the dental impression device against a dental structure in a patient's mouth, and reducing the size of the internal cavity during the formation of the impression.

These and other objects, features and advantages of the present invention will become more apparent upon reading the following specification in conjunction with the accompanying drawing figures.

### BRIEF DESCRIPTION OF THE FIGURES

FIG. 1A provides an illustration of a dynamically adjustable dental impression device 100 in accordance with an exemplary embodiment of the present invention.

FIG. 1B provides an illustration of a harbor 135 of a dynamically adjustable dental impression device 100 in accordance with an exemplary embodiment of the present invention.

FIG. 2A provides an illustration of a dynamically adjustable dental impression device 100 in accordance with an exemplary embodiment of the present invention.

FIG. 2B provides an illustration of a dynamically adjustable dental impression device 100 in accordance with an exemplary embodiment of the present invention.

FIG. 2C provides an illustration of a dynamically adjustable dental impression device 100 in accordance with an exemplary embodiment of the present invention.

FIG. 3 provides a flow diagram of a method for forming a dental impression 300 in accordance with an exemplary embodiment of the present invention.

FIG. 4 provides an illustration of a dynamically adjustable dental impression device 100 in accordance with an exemplary embodiment of the present invention.

FIG. 5 provides an illustration of full arch dynamically adjustable dental impression device 100 in accordance with an exemplary embodiment of the present invention.

FIG. 6 provides an illustration of an arcuate dynamically adjustable dental impression device 100 in accordance with an exemplary embodiment of the present invention.

FIG. 7 provides an illustration of a quadrant dynamically adjustable dental impression device 100 in accordance with an exemplary embodiment of the present invention.

FIG. 8 provides an illustration of a spring-biased dynamically adjustable dental impression device 100 in accordance with an exemplary embodiment of the present invention.

### DETAILED DESCRIPTION OF PREFERRED EMBODIMENTS

The present invention addresses the deficiencies in the prior art concerning the ability to provide quick, precise and accurate dental impressions. Significantly, the present invention provides methods and apparatus for providing dynamically adjustable dental impression devices. A dynamically adjustable dental impression device provided in accordance with the present invention is enabled to provide a precise and accurate model of a dental structure. The present invention overcomes the drawbacks of the conventional methods and systems in the prior art and provides systems and methods enabled to actively and dynamically adjust the dental impression device during the formation of an impression.

In an exemplary embodiment, the present invention provides a dynamically adjustable dental impression device including a facial portion having at least a first wall and a lingual portion having at least a first wall. The facial portion is movably connected to the lingual portion to form an internal cavity enabled to receive a quantity of impression material. Furthermore, the size of the internal cavity can be reduced during the formation of an impression of a dental structure.

In some embodiments, the facial portion can be contracted with the lingual portion during the formation on the impression of the dental structure, resulting in the reduction in the size of the internal cavity. Additionally, in some embodiments, the reduction in the size of the internal cavity during the formation on the impression of the dental structure can increase the hydrostatic pressure within the quantity of impression material. Furthermore, the adjustable dental impression device can simultaneously apply forces substantially nonparallel and substantially parallel to the long axis of the tooth in the dental structure.

In addition to dynamically adjustable dental impression devices, the present invention provides methods for forming a dental impression. An exemplary embodiment of the method for forming a dental impression involves providing a dynamically adjustable dental impression device comprising a facial portion having at least a first wall and a lingual portion having at least a first wall. The facial portion is moveably connected to the lingual portion to form an internal cavity enabled to receive a quantity of impression material. The method for forming a dental impression further involves inserting the quantity of impression material into the internal cavity. Additionally, the method involves forming an impression by pressing a portion of the quantity of impression material in the dental impression device against a dental structure in a patient's mouth, and reducing the size of the internal cavity during the formation of the impression.

The term “facial” is used herein to describe the cheek side of the teeth, including the buccal side and labial side and other areas of the teeth or gum surface near the cheek. The term “lingual” is used herein to describe the inner mouth side of the teeth, including the lingual side and the palatal side of the teeth. The term “dental structure” is used herein to describe any portion or feature of the mouth, including a tooth, portions of a patient's teeth, tooth formations, implant parts, the contour of the gum, and adjacent portions of the jaw, and dental prosthesis. The term “long axis of the tooth” is used herein to describe a line through the occlusal center of the tooth passing through the center of the root area of the tooth.

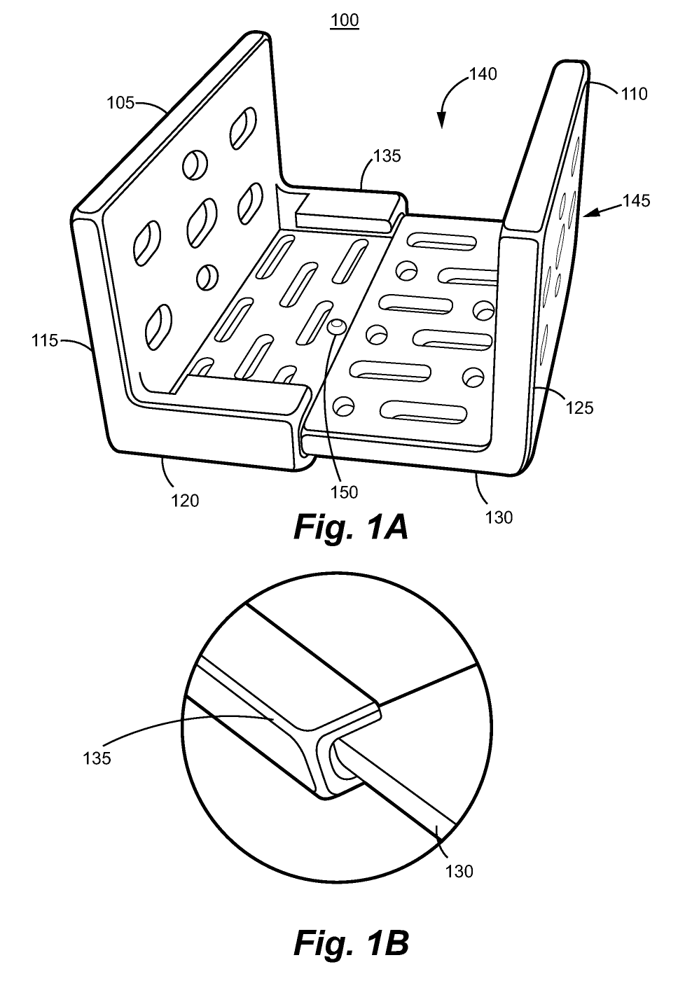

FIG. 1A provides an illustration of a dynamically adjustable dental impression device 100 in accordance with an exemplary embodiment of the present invention. As shown in the exemplary embodiment of FIG. 1A, the dynamically adjustable dental impression device 100 provides a facial portion 105 and a lingual portion 110. As shown in the exemplary embodiment depicted in FIG. 1A, the facial portion 105 and the lingual portion 110 can be separate and independent elements. In an alternative embodiment, the facial portion 105 and lingual portion 110 are connected and form one contiguous dental impression device 100. The facial portion 105 and the lingual portion 110 of the dynamically adjustable dental impression device 100 can be made of a variety of materials, including acrylics, plastics, other polymers, metals, and or alloys.

In the exemplary embodiment in FIG. 1A, the facial portion 105 of the dynamically adjustable dental impression device 100 is made up of a first wall 115 and a second wall 120. The first wall 115 and second wall 120 can be positioned at a variety of suitable angles. In the exemplary embodiment shown in FIG. 1A, the first wall 115 of the facial portion 105 is oriented 90 degrees from the second wall 120. In other embodiments, the angle between the first wall 115 and the second wall 120 can vary between 45 degrees and 135 degrees. Those of skill in the art will appreciate that the angle of the separation between first wall 115 and the second wall 120 can vary according to the implementation without detracting from the scope the invention. Similar to the facial portion 105, the lingual portion 110 has a first wall 125 and a second wall 130. In the exemplary embodiment shown in FIG. 1A, the first wall 125 of the lingual portion 110 is oriented 90 degrees from the second wall 130. In other embodiments, the angle between the first wall 125 and the second wall 130 of the lingual portion 110 can vary between 45 degrees and 135 degrees. Those of skill in the art will appreciate that the angle of the separation between first wall and second walls of the facial portion 105 and lingual portion 110 can vary according to the implementation without detracting from the scope the invention.

In the exemplary embodiment of the dynamically adjustable dental impression device 100 shown in FIG. 1A, the facial portion 105 of the dynamically adjustable dental impression device 100 provides a harbor 135 for releasably engaging the lingual portion 110. The harbor 135 shown in the exemplary embodiment in FIG. 1 consists of two flaps that hang over the internal portion of the second wall 120 of the facial portion 105 on each side of the second wall 120.

FIG. 1B provides an illustration of a harbor 135 of a dynamically adjustable dental impression device 100 in accordance with an exemplary embodiment of the present invention. The harbor 135 in this exemplary embodiment of the dynamically adjustable dental impression device 100 shown in FIG. 1B is provided such that the second wall 130 of the lingual portion 110 can be inserted beneath the flap extending from the second wall 120 of the facial portion 105. As shown in FIG. 1B, the lingual portion 110 can be releasably and moveably connected to the facial portion 105 by inserting the second wall 130 of the lingual portion 110 into harbor 135 of the facial portion 105. As shown in FIG. 1B, the lingual portion 110 can be permitted to slide back and forth in the harbor 135. Thereby, the lingual portion 110 and the facial portion 105 and can be moveably connected and then subsequently separated without damage to either portion of the exemplary embodiment of the dynamically adjustable dental impression device 100.

The exemplary embodiment of the dynamically adjustable dental impression device 100 shown FIG. 1A illustrates that the facial portion 105 can provide a friction component 150. This friction component can aid in an exemplary embodiment in ensuring a proper amount of friction exists when the lingual portion 110 is inserted into the harbor 135 of the facial portion 105. Therefore, the movably connected lingual portion 110 and facial portion 105 can be precisely fitted so as to allow a proper amount of slidable friction between the portions so as to enable the portions to fit properly together but still enable movement.

In an alternative embodiment, harbor 135 of the dynamically adjustable dental impression device 100 can be one or more grooves in the facial portion 105 into which corresponding prongs in the lingual portion 110 can be inserted. In this alternative embodiment, the lingual portion 110 can be releasably connected to the facial portion 105 of the dynamically adjustable dental impression device 100.

As shown in the exemplary embodiment of the dynamically adjustable dental impression device 100 FIG. 1A, the facial portion 105 and the lingual portion 110 can be moveably connected to form internal cavity 140. Those of skill in the art will appreciate that the lingual portion 110 and the facial portion 105 can be permanently connected in an alternatively embodiment and allowed to slide in relation to each other. In an exemplary embodiment, the internal cavity 140 is enabled to receive a quantity of impression material. The impression material is a dental compound that can provide a soft paste material for forming the impression that can quickly harden. Those of skill in the art will appreciate that suitable impression materials can be made from a variety of materials, including, but not limited to, alginate, hydro colloid, polyvinyl siloxanes, polyethers and rubber base.

As shown in FIG. 1A, the exemplary embodiment of the dynamically adjustable dental impression device 100 provides one or more apertures 145 in both the facial portion 105 and the lingual portion 110. In an exemplary embodiment of the lingual portion 110 and the facial portion 105, a portion of the quantity of the impression material can be enabled to partially flow through the apertures 145. By flowing through the apertures 145, the impression material can be affixed within the internal cavity 140 of an exemplary embodiment of the dynamically adjustable dental impression device 100. Furthermore, in an exemplary embodiment of the dynamically adjustable dental impression device 100, the apertures 145 of the facial portion 105 can be configured to partially or fully align with the apertures 145 in the lingual portion 110, such that a portion of the quantity of impression material can flow through both the aperture 145 in the lingual portion 110 and the facial portion 105 when the facial portion 105 and the lingual portion 110 are moveably connected. In some embodiments, the flow of impression material through the apertures 145 can aid in holding the components of the dynamically adjustable dental impression device 100 in place in the final relationship; thus, apertures 145 can act as stabilization holes.

Those of skill in the art will appreciate that some embodiments dynamically adjustable dental impression device 100 do not provide apertures, such as apertures 145. Alternative embodiments of the dynamically adjustable dental impression device 100 can be solid, perforated, watercooled, made of plastic, polymer, metal, alloy, carbon or other material of similar properties, or any combination of these properties.

Once the impression material has been inserted into the internal cavity of an exemplary embodiment of the dynamically adjustable dental impression device 100, the device 100 can then be seated in the target area of the mouth to form the desired impression. Significantly, in accordance with the present invention, the dynamically adjustable dental impression device 100 can be dynamically adjusted during the impression. More particularly, the dental operator can cause the facial portion 105 and the lingual portion 110 of the dynamically adjustable dental impression device 100 to contract together during the impression, thereby reducing the size of the internal cavity 140 during the impression. Enabling the dental operator to reduce the size of the internal cavity 140 during the formation of the impression enables the dental operation to increase the hydrostatic pressure within the internal cavity 140 of an exemplary embodiment of the dynamically adjustable dental impression device 100. Additionally, an exemplary embodiment of the dynamically adjustable dental impression device 100 enables the application of forces that are substantially nonparallel to the long axis of the tooth. Furthermore, the dental operator can be enabled by an exemplary embodiment of the dynamically adjustable dental impression device 100 to simultaneously apply forces to the impression material that are substantially parallel to the long axis of the tooth, and substantially nonparallel to the long axis of the tooth, including perpendicular forces, forces at a 45 degree angle, and other angles.

In the exemplary embodiment of the dynamically adjustable dental impression device 100 shown in FIG. 1A, the facial portion 105 and lingual portion 110 both have an L-shaped structure made up of two walls. Those of skill in the art will appreciate that the facial portion 105 and the lingual portion 110 can be made up of any shape enabled to form an internal cavity when combined. Therefore, in one embodiment the facial portion 105 and the lingual portion 110 can have three or more walls. In an alternative embodiment, the facial portion 105 and the lingual portion 110 can have an arcuate shape. In this alternative embodiment, the arcuate facial portion 105 and the arcuate lingual portion 110 can connect together to form an arcuate dynamically adjustable dental impression device 100 having internal cavity 140. Furthermore, the arcuate facial portion 105 and the arcuate lingual portion 110 in this alternative embodiment can be contracted together to reduce the size of the internal cavity 140.

In an exemplary embodiment, the dynamically adjustable dental impression device 100 can be used to form an impression for a temporary restoration, such as temporary crown. To make a temporary crown or other temporary dental indirect replacement, an impression is often taken before any removal of tooth substance. The more accurately this impression forms to the dental structures to be temporized, the better the temporary will fit, reducing discomfort and injury to the oral structures. The dynamically adjustable dental impression device 100 enabled by the present invention helps create accuracy through fewer voids or pulls of impression material away from areas of importance.

Although not depicted in FIG. 1A, an exemplary embodiment of the dynamically adjustable dental impression device 100 can provide a handle or other component to assist the dental operator in contracting the lingual portion 110 and the facial portion 105 together or to help position the device in the mouth. In one exemplary embodiment, a handle is provided on both the facial portion 105 and the lingual portion 110 such that the dental operator can push on these handles to move the portions 105 and 110 together. Alternatively, an exemplary embodiment of the dynamically adjustable dental impression device 100 may include an instrument that the dental operator can use in reducing the size of the internal cavity 140 of the device 100. For example, and not limitation, a clamp tool can be provided that would enable the dental operator to clamp together the facial portion 105 and the lingual portion 110. In another embodiment, a rotary component is provided on the dynamically adjustable dental impression device 100 that can be turned by the dental operator during the formation of impression to contract the facial portion 105 and lingual portion 110 together. Those of skill in the art will appreciate that a variety of different tools and instruments can be used to reduce the size of internal cavity of an exemplary embodiment of the dynamically adjustable dental impression device 100 during the formation of an impression without detracting from the scope of the invention.

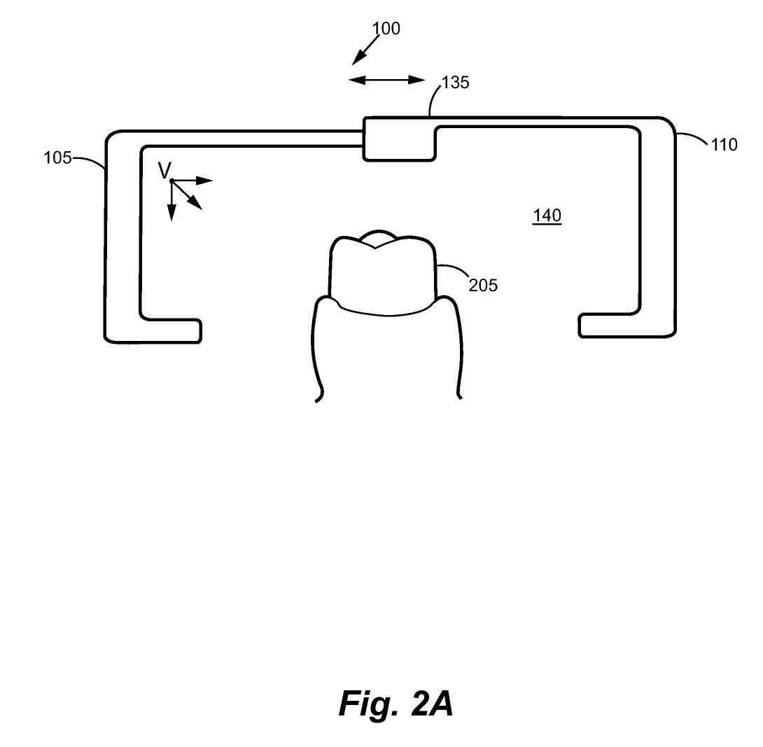

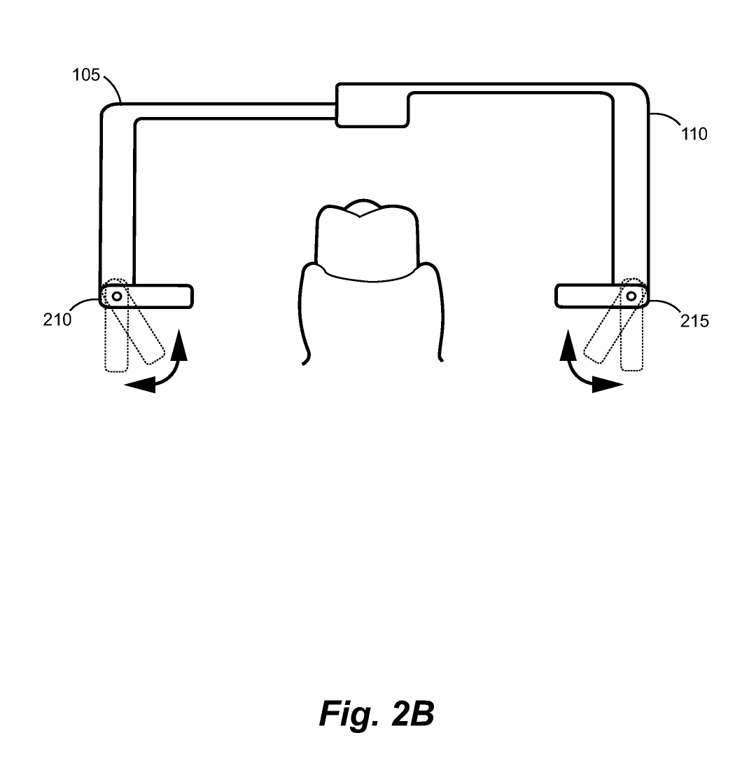

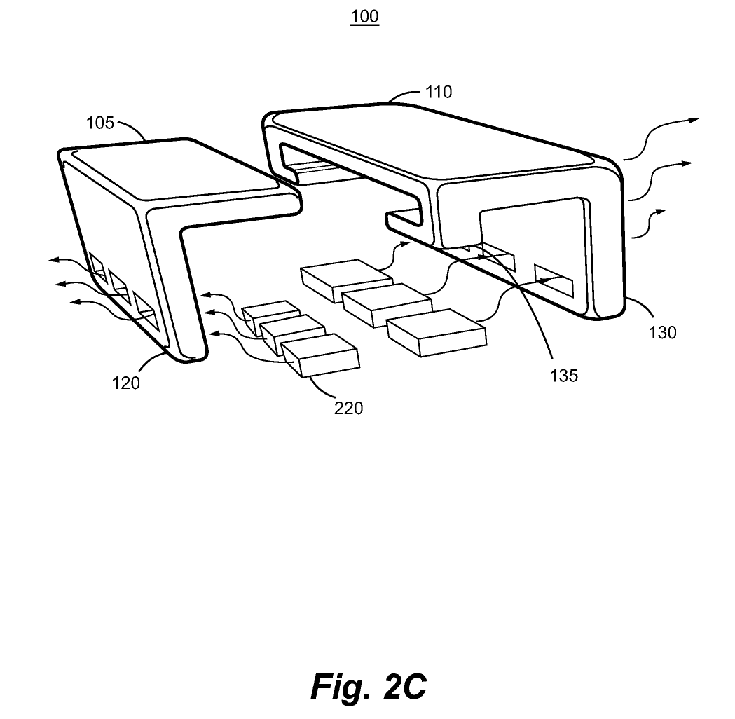

FIG. 2A provides an illustration of a dynamically adjustable dental impression device 100 in accordance with an exemplary embodiment of the present invention. As shown in FIG. 2A, facial portion 105 and the lingual portion 110 of an exemplary embodiment of the dynamically adjustable dental impression device 100 can be releasably engaged with harbor 135 to form internal cavity 140. This internal cavity 140 can be filled with a quantity of impression material. Once the exemplary embodiment of the dynamically adjustable dental impression device 100 has been prepared for an impression, the device 100 can be seated on the target area of the mouth, such as tooth 205 shown in FIG. 2A. During the seating of the exemplary embodiment of the dynamically adjustable dental impression device 100, the device 100 can be dynamically contracted, bringing facial portion 105 closer to the lingual portion 110 and reducing the size of the internal cavity 140, during the formation of the impression. Reducing the size of the internal cavity 140 during the formation of the impression can increase the hydrostatic pressure within the quantity of impression material. The ability to reduce size of an exemplary embodiment of the dynamically adjustable dental impression device 100 allows the dental operator to alter the direction (vector) and extent of forces and timing of those force vectors in relation to each other as placed on impression material being adapted to dental structures. For example, and not limitation, the exemplary embodiment of the dynamically adjustable dental impression device 100 enables the dental operator to simultaneously apply forces to the impression material that are both substantially parallel to the long axis of the tooth and substantially nonparallel to the long axis of the tooth. For example, and not limitation, FIG. 2A illustrates some of the vectors “V” of forces that the dental operator can apply to impression material in the internal cavity 140 of an exemplary embodiment of the dynamically adjustable dental impression device 100 during the formation of an impression. As shown in the exemplary embodiment in FIG. 2A, a downward force, parallel to the long axis of the tooth, a horizontal force, perpendicular to the long axis of the tooth, and diagonal force, at a 45 degree angle to the long axis of the tooth, can be applied by the dental operator during the formation of an impression. Those of skill in the art will appreciate that many other vectors of force are possible. The various vectors “V” of force provided by the dental operator during the formation of an impression by an exemplary embodiment of the dynamically adjustable dental impression device 100 can aid creating a substantially improved and precisely accurate impression. Not only does an exemplary embodiment of the dynamically adjustable dental impression device 100 offer a number of different vectors of force to the dental operator, it also enables the dental operator to control the timing of the application of those forces during the impression. For example, and not limitation, it may be advantageous to first apply pressure perpendicular to the long axis of the tooth at the beginning of the impression, and then follow with an application of force parallel to the long axis of the tooth. In another embodiment, it may be advantageous to simultaneously apply those forces.

By increasing the hydrostatic pressure in the quantity of impression material in the internal cavity 140 of an exemplary embodiment of the dynamically adjustable dental impression device 100, more force and at varied vectors can be applied to the impression material at various stages of the seating the device 100. Furthermore, in an exemplary embodiment the contracting of the facial portion 105 and the lingual portion 110 can squeeze the impression material and thereby force out air bubbles, tissue fluid, an other impurities that degrade the quality of the impression. Additionally, reducing the internal cavity 140 size of an exemplary embodiment of the dynamically adjustable dental impression device 100 enables impression material pulls to be pushed away from the dental structures being impressed, or even completely removed from the operative area. Because of this extra versatility in the application of force during the formation of an impression with an exemplary embodiment of the dynamically adjustable dental impression device 100, syringing of impression material around the tooth or other structure of interest may not be needed for complete contact and coverage of the area with impression material, leading to increased time efficiency. A significant advancement of the devices and methods of the present invention is that they enable control over the timing and delivery of a variety of vectors of forces to impression material during the formation of an impression.

FIG. 2B provides an illustration of a dynamically adjustable dental impression device 100 in accordance with an exemplary embodiment of the present invention. As shown in FIG. 2B, facial portion 105 and the lingual portion 110 of an exemplary embodiment of the dynamically adjustable dental impression device 100 provide hinged components 210 and 215. In an exemplary embodiment, these hinged components 210 and 215 can move in association with the contour of a patient's gum or other dental structure during the formation of the impression. In an exemplary embodiment, these hinged components 210 and 215 can aid in retaining the impression material inside the internal cavity 140 of the dynamically adjustable dental impression device 100 and also create additional vectors of force on impression material toward margins of prepared teeth or implant parts. Thereby, the exemplary embodiment of the dynamically adjustable dental impression device 100 can further increase the hydrostatic pressure in the impression material during the seating of the device 100 and the formation of the impression.

FIG. 2B provides an illustration of a dynamically adjustable dental impression device 100 in accordance with an exemplary embodiment of the present invention. As shown in FIG. 2B, facial portion 105 and the lingual portion 110 of an exemplary embodiment of the dynamically adjustable dental impression device 100 provide slideable components 220. In an exemplary embodiment, these slideable components 220 can move in association with the contour of a patient's gum or other dental structure during the formation of the impression. In an exemplary embodiment, these slideable components 220 can aid in retaining the impression material inside the internal cavity 140 (not shown) of the dynamically adjustable dental impression device 100 and also create additional vectors of force on impression material toward margins of prepared teeth or implant parts. Thereby, the exemplary embodiment of the dynamically adjustable dental impression device 100 can further increase the hydrostatic pressure in the impression material during the seating of the device 100 and the formation of the impression.

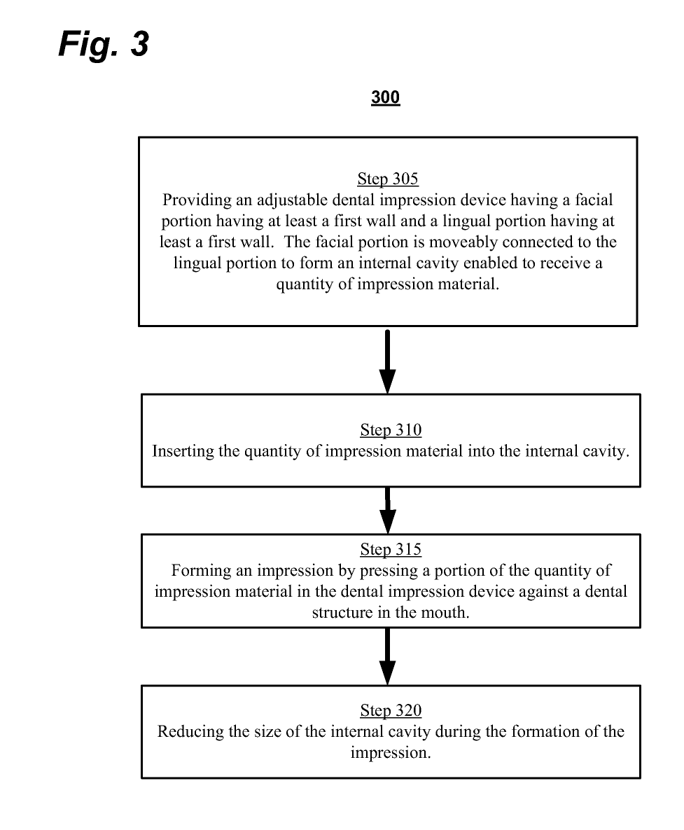

FIG. 3 provides a flow diagram of a method for forming a dental impression 300 in accordance with an exemplary embodiment of the present invention. As shown in FIG. 3, the first step 305 of an exemplary embodiment of the method for forming a dental impression 300 involves providing a dynamically adjustable dental impression device 100 with a facial portion 105 having at least a first wall 115 and a lingual portion 110 having at least a first wall 125. In an exemplary embodiment of the method for forming a dental impression 300 the facial portion 105 is movably connected to the lingual portion 110, thus forming an internal cavity 140 enabled to receive a quantity of impression material. Those of skill in the art will appreciate that the facial portion 105 and the lingual portion 110 can be separate and independent components that can be connected together or they can be two moveably connected components of a single unitary body of the dynamically adjustable dental impression device 100. Those of skill in the art will appreciate that there are a number of ways to connect the lingual portion 110 and the facial portion 105 of an exemplary embodiment of the dynamically adjustable dental impression device 100, including engaging the lingual portion 110 into a harbor 135 in the facial portion 105 and other variations. The second step 310 of an exemplary embodiment of the method for forming a dental impression 300 shown in FIG. 3 involves inserting the quantity of impression material into the internal cavity. The third step 315 of an exemplary embodiment of the method for forming a dental impression 300 involves forming an impression by pressing a portion of the quantity of impression material in the dental impression device against a dental structure in the mouth. Additionally, the fourth step 320 of the method for forming a dental impression 300 involves reducing the size of the internal cavity 140 during the formation of the impression. Those of skill in the art will appreciate that there are a number of suitable ways to reduce the size of the internal cavity 140 in an exemplary embodiment of the method for forming a dental impression 300. For example, and not limitation, the facial portion 105 and the lingual portion 110 of the dynamically adjustable dental impression device 100 can be slideably moved together or compressed to reduced the size of the internal cavity 140.

In an exemplary embodiment of the method for forming a dental impression 300, contracting together facial portion 105 and the lingual portion 110 of the dynamically adjustable dental impression device 100 will reduce the size of the internal cavity 140, thereby increasing the hydrostatic pressure within the quantity of impression material. The ability to reduce size of an exemplary embodiment of the dynamically adjustable dental impression device 100 allows the dental operator to alter the direction (vector) and extent of forces and timing of those force vectors in relation to each other as placed on impression material being adapted to dental structures. By increasing the hydrostatic pressure in the quantity of impression material in the internal cavity 140 of an exemplary embodiment of the dynamically adjustable dental impression device 100, more force can be applied to the impression material at various stages of seating the device 100, such as on forces substantially nonparallel to the long axis of a tooth. Furthermore, in an exemplary embodiment the contracting of the facial portion 105 and the lingual portion 110 can squeeze the impression material and thereby force out air bubbles, tissue fluid, and other impurities that degrade the quality of the impression.

The embodiments of the method for forming a dental impression 300 provide a significant improvement over the prior art, as conventional impression methods and techniques do not enable the dental operator to dynamically alter the impression device during the formation of the impression. Certain conventional dental impression devices may allow for the dental operator to adjust or create a custom or semi-custom impression tray before the impression is formed, but they do not enable dynamic adjustment of the impression tray during the formation of the impression. This dynamic adjustment of the impression device 100 in accordance with an exemplary embodiment of the method for forming a dental impression 300 significantly improves the accuracy of the impression generated by the procedure, and quickness of the procedure.

An exemplary embodiment of the dynamically adjustable dental impression device 100 provides a significant advancement over conventional impression trays by enabling the dental operator to control the direction of the forces induced on the impression material during the formation of a impression. For example and without limitation, the dental operator could start the impression by pressing an exemplary embodiment of the dynamically adjustable dental impression device 100 down on the target dental structure in the patient's mouth and then follow by compressing the lingual portion 110 and the facial portion 105 together. In an alternative embodiment, the dental operator could first compress together the facial portion 105 and the lingual portion 110 of an exemplary embodiment of the dynamically adjustable dental impression device 100 around the target dental structure and then press the dynamically adjustable dental impression device 100 down on the target dental structure. In yet another embodiment, the dental operator could simultaneously compress together the facial portion 105 and the lingual portion 110 of an exemplary embodiment of the dynamically adjustable dental impression device 100 around the target dental structure and press the dynamically adjustable dental impression device 100 down on the target dental structure. Those of skill in the art will appreciate that any combination of above actions is possible.

Those of skill in the art will appreciate that an exemplary embodiment of the dynamically adjustable dental impression device 100 can provide the dental operator with control over the timing of the dynamic adjustment of the dynamically adjustable dental impression device 100 during the formation of an impression. Therefore, the dental operator can alter the timing or the direction of forces in the compression of the components of an exemplary embodiment of the dynamically adjustable dental impression device 100 in accordance with a desired implementation. Furthermore, the dental operator can alter the extent to which certain forces are applied to the various components of an exemplary embodiment of the dynamically adjustable dental impression device 100 by adjusting the amount of pressure applied by the dental operator.

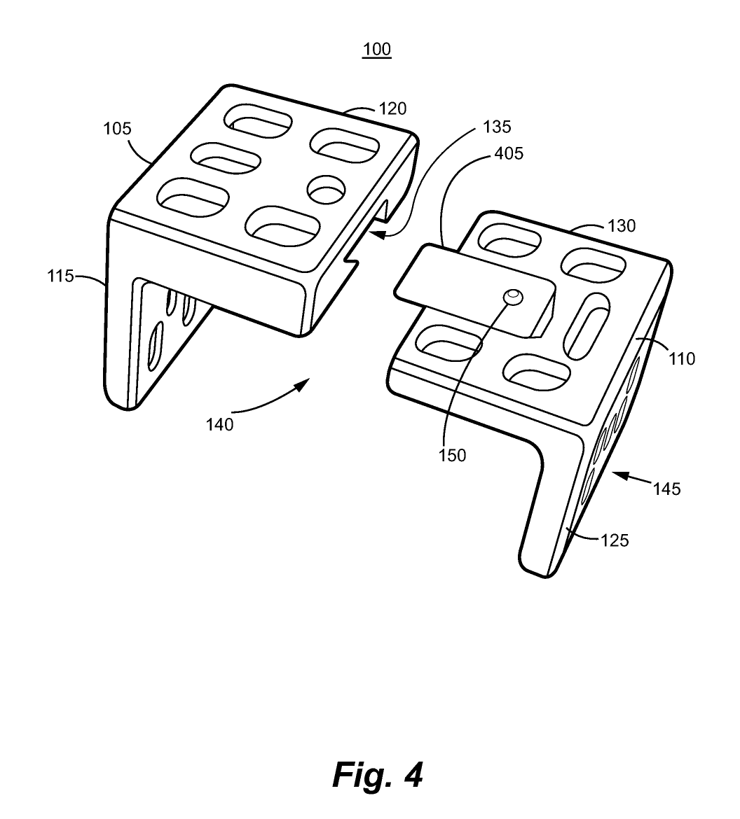

FIG. 4 provides an illustration of a dynamically adjustable dental impression device 100 in accordance with an exemplary embodiment of the present invention. As shown in the exemplary embodiment of FIG. 4, the dynamically adjustable dental impression device 100 provides a facial portion 105 and a lingual portion 110. As shown in the exemplary embodiment depicted in FIG. 4, the facial portion 105 and the lingual portion 110 can be separate and independent elements. In an alternative embodiment, the facial portion 105 and lingual portion 110 are connected and form one contiguous dental impression device 100. The exemplary embodiment of the dynamically adjustable dental impression device 100 shown in FIG. 4 provides an illustration of a partial impression tray. For example and not limitation, the exemplary embodiment shown in FIG. 4 can be used to impress a dental structure such a single tooth or small number of teeth. Those of skill in the art will appreciate that alternative embodiments of the dynamically adjustable dental impression device 100 can provide a sextant tray or a quadrant tray, or anterior tray, or a tray covering any portion of a dental arch. There are two dental arches: 1) upper jaw with upper teeth; 2) lower jaw with lower teeth. A quadrant tray covers ½ of one arch and a sextant tray covers ⅓ of one arch.

In the exemplary embodiment shown in FIG. 4, the facial portion 105 of the dynamically adjustable dental impression device 100 is made up of a first wall 115 and a second wall 120. The first wall 115 and second wall 120 can be positioned at a variety of suitable angles. In the exemplary embodiment shown in FIG. 4, the first wall 115 of the facial portion 105 is oriented 90 degrees from the second wall 120. In other embodiments, the angle between the first wall 115 and the second wall 120 can vary between 45 degrees and 135 degrees. Those of skill in the art will appreciate that the angle of the separation between first wall 115 and the second wall 120 can vary according to the implementation without detracting from the scope the invention. Similar to the facial portion 105, the lingual portion 110 has a first wall 125 and a second wall 130. In the exemplary embodiment shown in FIG. 4, the first wall 125 of the lingual portion 110 is oriented 90 degrees from the second wall 130. In other embodiments, the angle between the first wall 125 and the second wall 130 of the lingual portion 110 can vary between 45 degrees and 135 degrees. Those of skill in the art will appreciate that the angle of the separation between first wall and second walls of the facial portion 105 and lingual portion 110 can vary according to the implementation without detracting from the scope the invention.

In the exemplary embodiment of the dynamically adjustable dental impression device 100 shown in FIG. 4, the facial portion 105 of the dynamically adjustable dental impression device 100 provides a harbor 135 for releasably engaging the lingual portion 110. Furthermore, in the exemplary embodiment shown in FIG. 4, the lingual portion 110 of the dynamically adjustable dental impression device 100 provides a mating component 405. The harbor 135 on the facial portion 105 shown in the exemplary embodiment of the dynamically adjustable dental impression device 100 in FIG. 4 is configured to receive the mating component 405 of the lingual portion 110. Thereby, in this exemplary embodiment, the lingual portion 110 and facial portion 105 can be moveably connected. More particularly, the lingual portion 110 of the exemplary embodiment of the dynamically adjustable dental impression device 100 can be contracted with the facial portion 105 to reduce the size of the internal cavity 140 created between the lingual portion 110 and the facial portion 105. The exemplary embodiment of the dynamically adjustable dental impression device 100 shown FIG. 4 illustrates that the lingual portion 110 can provide a friction component 150. This friction component 150 can aid in an exemplary embodiment in ensuring a proper amount of friction exists when the lingual portion 110 is inserted into the harbor 135 of the facial portion 105.

As shown in FIG. 4, the exemplary embodiment of the dynamically adjustable dental impression device 100 provides one or more apertures 145 in both the facial portion 105 and the lingual portion 110. In an exemplary embodiment of the lingual portion 110 and the facial portion 105, a portion of the quantity of the impression material can be enabled to partially flow through the apertures 145. By flowing through the apertures 145, the impression material can be affixed within the internal cavity 140 of an exemplary embodiment of the dynamically adjustable dental impression device 100. Furthermore, in an exemplary embodiment of the dynamically adjustable dental impression device 100, the apertures 145 of the occlusal surface of the facial portion 105 can be configured to partially or fully align with the apertures 145 of the occlusal surface of the lingual portion 110, such that a portion of the quantity of impression material can flow through both the apertures 145 in the lingual portion 110 and the facial portion 105. In some embodiments, the flow of impression material through the apertures 145 will aid in holding the components of the dynamically adjustable dental impression device 100 in place.

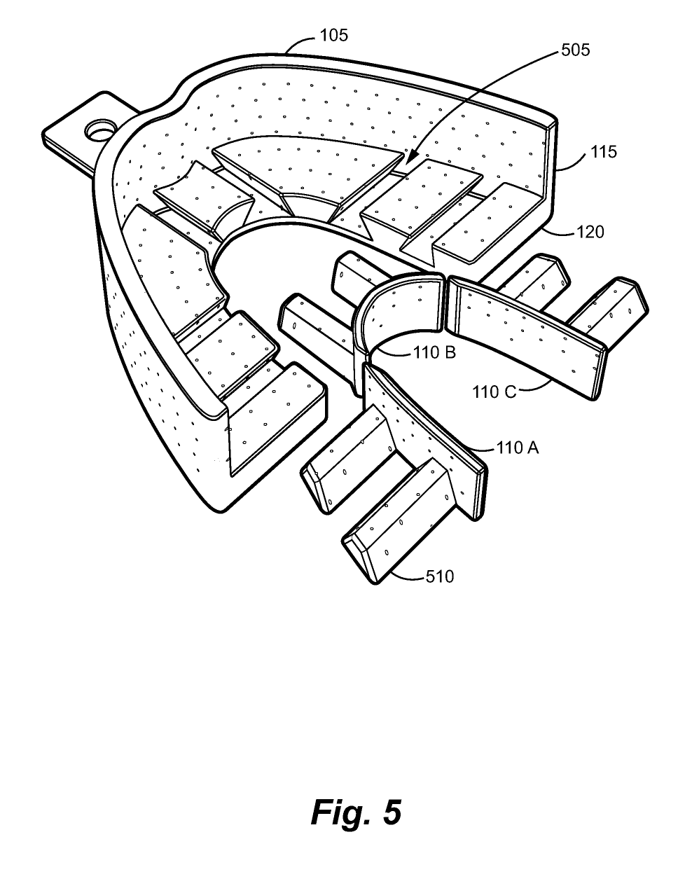

FIG. 5 provides an illustration of full arch dynamically adjustable dental impression device 100 in accordance with an exemplary embodiment of the present invention. As shown in FIG. 5, the exemplary embodiment of the full arch dynamically adjustable dental impression device 100 can be used by the dental operator to create an impression of the entire arch of a patient's lower teeth or a patient's upper teeth. Alternatively, the full arch dynamically adjustable dental impression device 100 can be used to create an impression of a portion of the entire arch of a patient's lower teeth or a patient's upper teeth. As shown in FIG. 5, the exemplary embodiment of the full arch dynamically adjustable dental impression device 100 provides a facial portion 105 having a first wall 115 and a second wall 120. The facial portion 105 of an exemplary embodiment of the full arch dynamically adjustable dental impression device 100 is enabled to span the entire arch of a patient's lower teeth or a patient's upper teeth. In the exemplary embodiment of the full arch dynamically adjustable dental impression device 100 shown in FIG. 5, the second wall 120 of the facial portion 105 provides multiple harbors 505 for receiving a mating component of a lingual portion.

The exemplary embodiment of the full arch dynamically adjustable dental impression device 100 shown in FIG. 5 provides multiple lingual portions, such as lingual portions 110A, 110B, and 110C. In an exemplary embodiment, each of these lingual portions 110A, 110B, and 110C a separate and individual components. In alternative embodiment, the lingual portions 110A, 110B, and 110C can be connected or simply one lingual portion can be provided. The independent lingual portions 110A, 110B, and 110C shown in the exemplary embodiment of FIG. 5 provide a first wall 125 and mating components 510. The mating components 510 in an exemplary embodiment of the lingual portions 110A, 110B, and 110C are enabled to be inserted into the harbors 505 of the facial portion 105. In an exemplary embodiment, the dental operator can individually insert and press-in each of the lingual portions 110A, 110B, and 110C into the facial portion 105. In this exemplary embodiment, an internal cavity 140 (not shown in FIG. 5) can thereby be created between the lingual portions 110A, 110B, and 110C and the facial portion 105. Furthermore, during the formation of an impression, the dental operator is enabled to compress the lingual portions 110A, 110B, and 110C against the facial portion 105 and reduce the size of the internal cavity 140, thereby increasing the hydrostatic pressure present in the impression material in the internal cavity 140.

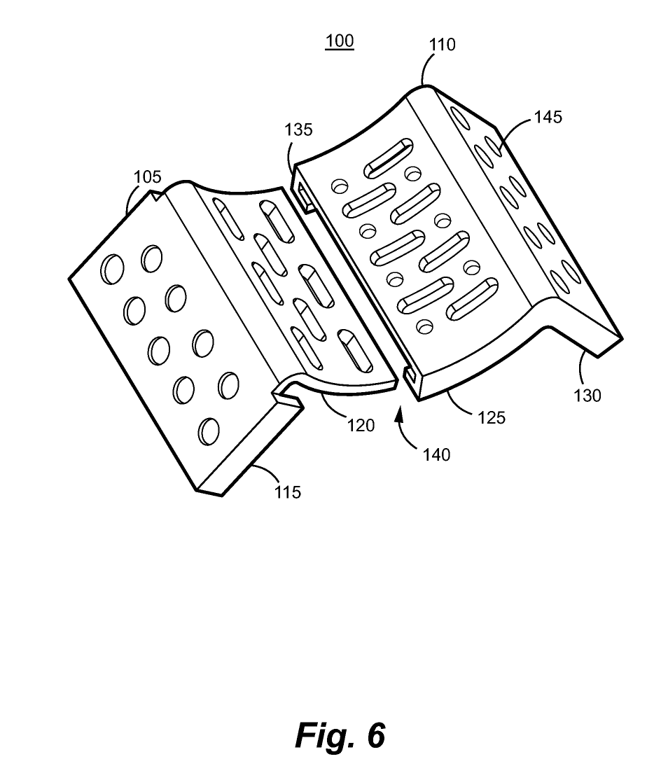

FIG. 6 provides an illustration of an arcuate dynamically adjustable dental impression device 100 in accordance with an exemplary embodiment of the present invention. As shown in FIG. 6, the exemplary embodiment of the arcuate dynamically adjustable dental impression device 100 provides a facial portion 105 and a lingual portion 110 having an arcuate shape. In the exemplary embodiment of the arcuate dynamically adjustable dental impression device 100, the facial portion 105 has a first wall 115 and a second wall 120. Similarly, in the exemplary embodiment of the arcuate dynamically adjustable dental impression device 100 shown in FIG. 6, the lingual portion 110 is provided with a first wall 125 and a second wall 130. In the exemplary embodiment shown in FIG. 6, the first wall 115 of the facial portion 105 can be oriented at an obtuse angle from the second wall 120. In some embodiments, this obtuse angle can range from 91 degrees to 135,—or be 90° or be acute at 45° to 89°. Upon closing, the opposite walls may be parallel or closer together occlusally or closer together at their apical ends.

The exemplary embodiment of the arcuate dynamically adjustable dental impression device 100 shown in FIG. 6 can provide a harbor 135 on the lingual portion 110 for releasably engaging the facial portion 105. The harbor 135 shown in the exemplary embodiment in FIG. 6 consists of two flaps that hang over the internal portion of the second wall 130 of the lingual portion 110 on each side of the second wall 130. As shown in FIG. 6, the facial portion 105 can be permitted to slide back and forth in the harbor 135 of the lingual portion 110. Thereby, the lingual portion 110 and the facial portion 105 and can be connected and then subsequently separated without damage to either portion of the exemplary embodiment of the dynamically adjustable dental impression device 100. Additionally, when the lingual portion 110 and the facial portion 105 of an exemplary embodiment of the arcuate dynamically adjustable dental impression device 100 are connected, an internal cavity 140 is created that can retain a quantity of impression material. Furthermore, the exemplary embodiment of the arcuate dynamically adjustable dental impression device 100 shown in FIG. 6, provides apertures 145 on both the facial portion 105 and the lingual portion 110, into which a portion of the quantity of impression material can pass. The material, on setting, acts to hold the parts together.

When the exemplary embodiment of the arcuate dynamically adjustable dental impression device 100 is used to form an impression, the movably connected facial portion 105 and lingual portion 110 can be compressed to reduce the size of the internal cavity 140 and increase the hydrostatic pressure present in the impression material located in the internal cavity 140. Furthermore, the angle between the first wall 115 of the facial portion 105 and the second wall 130 of the lingual portion 110 can be decreased, thereby increasing the forces present on the impression material surrounding the target dental structure.

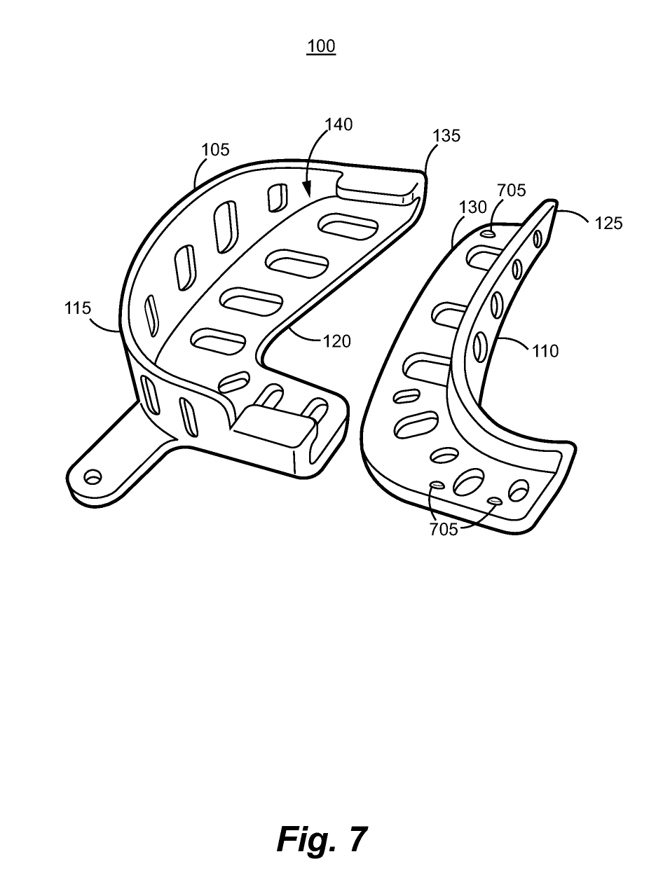

FIG. 7 provides an illustration of a quadrant dynamically adjustable dental impression device 100 in accordance with an exemplary embodiment of the present invention. The exemplary embodiment of the quadrant dynamically adjustable dental impression device 100 can enable the formation of an impression of an entire half of a patient's lower teeth or a patient's upper teeth. As shown in FIG. 7, the exemplary embodiment of the quadrant dynamically adjustable dental impression device 100 provides a facial portion 105 and a lingual portion 110. In the exemplary embodiment of the quadrant dynamically adjustable dental impression device 100, the facial portion 105 has a first wall 115 and a second wall 120. Similarly, in the exemplary embodiment of the arcuate dynamically adjustable dental impression device 100 shown in FIG. 7, the lingual portion 110 is provided with a first wall 125 and a second wall 130. In the exemplary embodiment shown in FIG. 7, the first wall 115 of the facial portion 105 is oriented at a predetermined angle from the second wall 120. In some embodiments, this predetermined angle can range from 45 degrees to 135 degrees. Similarly, in an exemplary embodiment the first wall 125 of the lingual portion 110 is oriented at a predetermined angle ranging from 45 to 135 degrees from the second wall 130 of the lingual portion 110.

In the exemplary embodiment of the quadrant dynamically adjustable dental impression device 100 shown in FIG. 7, the facial portion 105 of the dynamically adjustable dental impression device 100 provides a harbor 135 for releasably engaging the lingual portion 110. The harbor 135 shown in the exemplary embodiment in FIG. 7 consists of two flaps that hang over the internal portion of the second wall 120 of the facial portion 105 on each side of the second wall 120. The harbor 135 in this exemplary embodiment of the quadrant dynamically adjustable dental impression device 100 shown in FIG. 7 is provided such that the second wall 130 of the lingual portion 110 can be inserted beneath the flap of the harbor 135 extending from the second wall 120 of the facial portion 105. As shown in FIG. 7, the lingual portion 110 of the facial portion 105 can be releasably connected to the facial portion 105 by inserting the second wall 130 of the lingual portion 110 into harbor 135 of the facial portion 105. As shown in FIG. 7, the lingual portion 110 can be permitted to slide back and forth in the harbor 135. The exemplary embodiment of the dynamically adjustable dental impression device 100 shown FIG. 7 illustrates that the lingual portion 110 can provide friction components 705. These friction components 705 can aid in an exemplary embodiment in enabling a proper amount of friction when the lingual portion 110 is inserted into the harbor 135 of the facial portion 105. Thereby, the lingual portion 110 and the facial portion 105 and can be connected and then subsequently separated without damage to either portion of the exemplary embodiment of the dynamically adjustable dental impression device 100. An internal cavity 140 is created in the exemplary embodiment of the quadrant dynamically adjustable dental impression device 100 when the facial portion 105 and lingual portion 110 are movably connected together. Thereby, the dental operator can movably slide the facial portion 105 and lingual portion 110 to reduce the size of the internal cavity 140 and apply various forces to the impression material in the internal cavity 140, including forces substantially perpendicular to the long axis of a tooth.

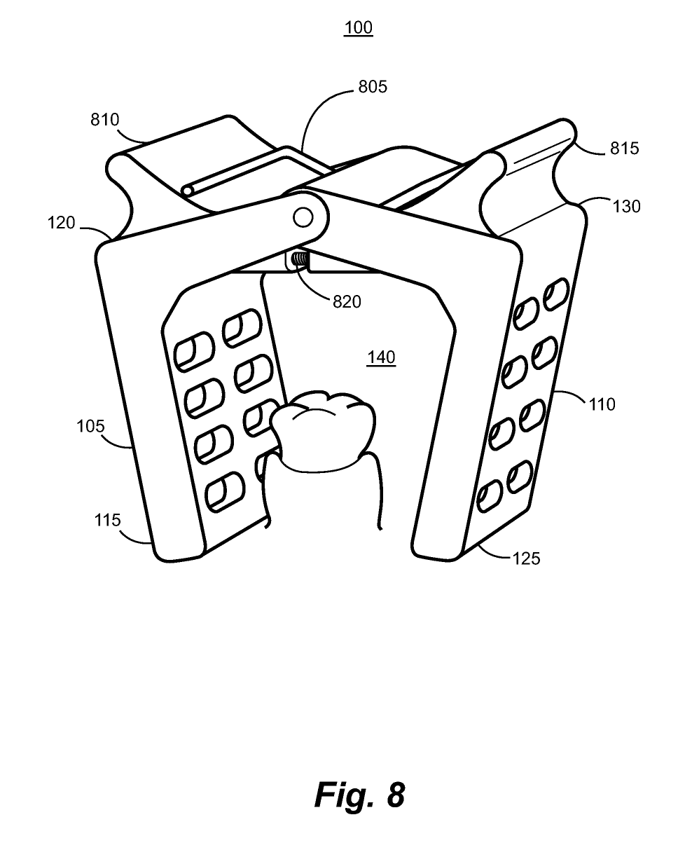

FIG. 8 provides an illustration of a spring-biased dynamically adjustable dental impression device 100 in accordance with an exemplary embodiment of the present invention. The exemplary embodiment of the spring-biased dynamically adjustable dental impression device 100 shown in FIG. 8 provides both a facial portion 105 and a lingual portion 110. In the exemplary embodiment of the spring-biased dynamically adjustable dental impression device 100, the facial portion 105 has a first wall 115 and a second wall 120. Similarly, in the exemplary embodiment of the spring-biased dynamically adjustable dental impression device 100 shown in FIG. 8, the lingual portion 110 is provided with a first wall 125 and a second wall 130. Furthermore, the exemplary embodiment of the spring-biased dynamically adjustable dental impression device 100 provides a spring component 805. In an exemplary embodiment, the spring component 805 can serve to bias the facial portion 105 against the lingual portion 110. The exemplary embodiment of the spring-biased dynamically adjustable dental impression device 100 shown in FIG. 8 provides a set screw 820. In An exemplary embodiment, the set screw 820 can be adjusted prior to placing impression material in the tray, by the dental operator, to provide an appropriate closed dimension for the spring-biased dynamically adjustable dental impression device 100. Thus, the set screw 820 can be modified to stop the spring-biased dynamically adjustable dental impression device 100 at a relatively wide width for a large tooth or a relatively small width for a small tooth in an exemplary embodiment. Thereby, the dental operator can ensure that an exemplary embodiment of the spring-biased dynamically adjustable dental impression device 100 provides the proper final dimension when the spring component 805 is released.

The exemplary embodiment of the arcuate dynamically adjustable dental impression device 100 can provide handles 810 and 815 on the facial portion 105 and the lingual portion 110 which can be used by the dental operator to compress the spring component 805. Thus, the dental operator using an arcuate dynamically adjustable dental impression device 100 can compress the spring component 805 prior to placement of the spring-biased dynamically adjustable dental impression device 100 about the target dental structure. Once the exemplary embodiment of the spring-biased dynamically adjustable dental impression device 100 has been placed in proximity to the target dental structure, the dental operator can release the handles 810 and 815 to compress the facial portion 105 and lingual portion 110, thereby decreasing the internal cavity 140 and increasing the force exerted on the impression material in the internal cavity.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A dynamically adjustable dental impression device comprising:
a facial portion having at least a first wall;
a lingual portion having at least a first wall;
wherein the facial portion is movably connected to the lingual portion to form an internal cavity enabled to receive a quantity of impression material; and
wherein the size of the internal cavity can be reduced during the formation of an impression of a dental structure.

2. The dynamically adjustable dental impression device of claim 1, wherein facial portion can be contracted with the lingual portion during the formation on the impression of the dental structure resulting in the reduction in the size of the internal cavity.

3. The dynamically adjustable dental impression device of claim 1, wherein the reduction in the size of the internal cavity during the formation on the impression of the dental structure can increase the hydrostatic pressure within the quantity of impression material.

4. The dynamically adjustable dental impression device of claim 1, wherein the reduction in the size of the internal cavity during the formation on an impression of a dental structure can apply forces substantially nonparallel to the long axis of a tooth in the dental structure.

5. The dynamically adjustable dental impression device of claim 4, wherein a portion of the dynamically adjustable dental impression device can be pressed down on the dental structure to apply forces substantially parallel to the long axis of the tooth in the dental structure.

6. The dynamically adjustable dental impression device of claim 5, wherein a portion of the dynamically adjustable dental impression device can be pressed down on the dental structure while simultaneously reducing the size of the internal cavity.

7. The dynamically adjustable dental impression device of claim 6, wherein the dynamically adjustable dental impression device can simultaneously apply forces substantially nonparallel and substantially parallel to the long axis of the tooth in the dental structure.

8. The dynamically adjustable dental impression device of claim 4, wherein lingual portion is enabled to move toward the facial portion.

9. The dynamically adjustable dental impression device of claim 1, wherein facial portion further comprises a second wall, wherein the first wall is positioned at a predetermined angle from the second wall and the predetermined angle ranges from 45 to 135 degrees.

10. A method for forming a dental impression, the method comprising:
providing an adjustable dental impression device comprising a facial portion having at least a first wall and a lingual portion having at least a first wall, wherein the facial portion is moveably connected to the lingual portion to form an internal cavity enabled to receive a quantity of impression material;
inserting the quantity of impression material into the internal cavity;
forming an impression by pressing a portion of the quantity of impression material in the dental impression device against a dental structure in a patient's mouth; and
reducing the size of the internal cavity during the formation of the impression.

11. The method for forming a dental impression of claim 10, wherein the reduction in the size of the internal cavity during the formation on an impression of a dental structure can increase the hydrostatic pressure within the quantity of impression material.

12. The method for forming a dental impression of claim 10, wherein reducing the size of the internal cavity during the formation of the impression involves moving the facial portion closer to the lingual portion.

13. The method for forming a dental impression of claim 12, wherein the dental structure is at least one tooth and reducing the size of the internal cavity during the formation of the impression applies forces to the quantity of impression material substantially nonparallel to the long axis of the tooth.

14. The method for forming a dental impression of claim 14, wherein the forming an impression by pressing a portion of the quantity of impression material in the dental impression device against the tooth applies forces to the quantity of impression material substantially parallel to the long axis of the tooth.

15. The method for forming a dental impression of claim 13, wherein the forming of an impression by pressing a portion of the quantity of impression material in the dental impression device against the tooth can involve simultaneously pressing down on the tooth and reducing the size of the internal cavity.

16. The method for forming a dental impression of claim 13, wherein the forming an impression by pressing a portion of the quantity of impression material in the dental impression device against the dental structure simultaneously applies forces substantially nonparallel and substantially parallel to the long axis of the tooth in the dental structure.

17. The method for forming a dental impression of claim 10, wherein facial portion further comprises a second wall, wherein the first wall is positioned at a predetermined angle from the second wall and the predetermined angle ranges from 45 to 135 degrees.

18. A method for forming a dental impression, the method comprising:
pressing a quantity of impression material in a dental impression device against a dental structure in a patient's mouth;
compressing the size of the dental impression device while pressing the quantity of impression material in the dental impression device against the dental structure; and
wherein the compression of the dental impression device reduces the size of an internal cavity in the dental impression device during the formation of the impression.

19. The method for forming a dental impression of claim 18, wherein the internal cavity is enabled to receive a quantity of impression material and the reduction in the size of the internal cavity during the compressing the size of the dental impression device can increase the hydrostatic pressure within the quantity of impression material.

20. The method for forming a dental impression of claim 18, wherein the dental structure is at least one tooth and the reduction in the size of the internal cavity during the formation on an impression applies forces to the quantity of impression material substantially nonparallel to the long axis of the tooth.

21. A method for forming a dental impression, the method comprising:
pressing a quantity of impression material in a dental impression device against a dental structure in a patient's mouth, wherein the dental impression device comprises a facial portion and a lingual portion; and
moving the facial portion closer to the lingual portion while pressing the dental impression device against the dental structure.
